(19) United States
(12) Patent Application Publication
(10) Pub. No.: US 2022/0178610 A1
(43) Pub. Date: Jun. 9, 2022

(54) BIOMASS DRYER

(71) Applicant: Brian James, San Ramon, CA (US)

(72) Inventor: Brian James, San Ramon, CA (US)

(21) Appl. No.: 17/481,059

(22) Filed: Sep. 21, 2021

Related U.S. Application Data
(60) Provisional application No. 63/081,122, filed on Sep. 21, 2020.

(51) Int. Cl. F26B 3/06; F26B 15/10; F26B 21/00; F26B 25/00

(52) U.S. Cl. CPC F26B 3/06; F26B 15/105; F26B 2200/02; F26B 25/007; F26B 21/002

(57) ABSTRACT

A system and method for drying individual biomass units. Turbine exhaust heats ambient air to produce heated air, which passes through a conveyor system that carries a quantity of biomass product to an endpoint collection area. Heated air with fine product particles is ducted to a series of cyclonic particle separators and collected.

### CLAIM OF PRIORITY

This application claims the benefit of priority to U.S. Provisional Application No. 63/081,122, filed 21 Sep. 2020, the complete contents of which is hereby incorporated herein by reference.

### BACKGROUND

### Technical Field

The present device relates to the field of drying technology and more particularly to apparatus and methods for drying biomasses.

### Background

In some types of agriculture, it is desired to have an end-product that can be dried to desired moisture levels for better storage and use. However, drying can be a complex process involving temperature, humidity, air flow rates, and other factors. In addition, it may be convenient to dry the product in the field to reduce product mass and transport costs. What is needed is a portable and efficient drying system for agricultural products.

### BRIEF DESCRIPTION OF DRAWINGS

FIG. 1a depicts a side view of an embodiment of the present system.

FIG. 1b depicts a top planar view of an embodiment of the present system.

FIG. 2 depicts schematic of an embodiment of the present system.

FIG. 3a depicts a side detail view of an embodiment of the present system.

FIG. 3b depicts a top planar detail view of an embodiment of the present system.

FIG. 4 depicts a top planar detail view of the two parts of the present system in use together.

FIG. 5 depicts a flow diagram of an embodiment of the present method.

FIG. 6 depicts a schematic diagram of a computer system used in an embodiment of the present system.

FIGS. 7a and 7b depict cross-sectional views of dryer bed conveyor troughs.

### SUMMARY

Exhaust from turbines used to power a drying system can be used to heat the air that passes through the product to be dried. Product can be moved through a space on a rotary conveyor bed, while the heated air moves through it. At the end of the conveyor, product can be discharged and packaged. This air that has passed through the product can contain fine particles of the product, which can be ducted to a fine product collection system. In this system, the air with the particles passes though primary and a secondary cyclonic particle separator. The fine product is collected on another conveyor, discharged, and packaged.

### DETAILED DESCRIPTION

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

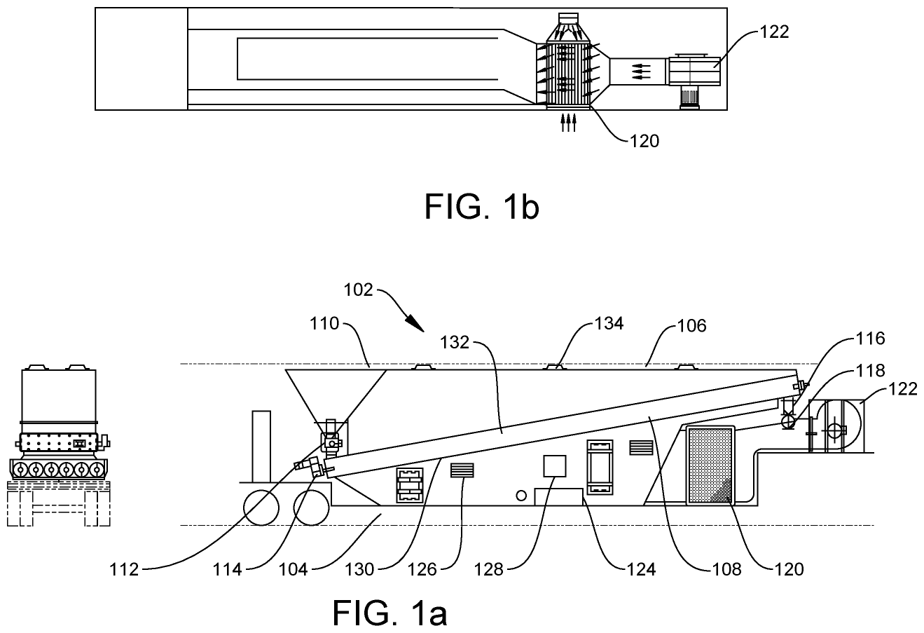

FIGS. 1a and 1b depict an embodiment of the present biomass drying system. FIG. 1a depicts a side view of an embodiment of the present system. In some embodiments a dryer housing 102 can comprise a lower plenum 104, an upper plenum 106, and a drying bed conveyor 108. As shown in FIG. 1a, a dryer housing 102 can be contained in a trailer that can be hauled by a tractor rig, but in other embodiments can have any other known and/or convenient configuration. In some embodiments, a drying bed 108 can be perforated, mesh, or any other known and/or convenient surface. An intake hopper 110 can be positioned at one end of a drying bed conveyor 108. Wet material to be dried can be fed into a hopper 110 and metered into a drying bed conveyor 108 using a rotary feeder 112, which can also help keep the heated air inside the dryer housing 102. In embodiments in which a drying bed conveyor 108 can be at an elevated angle with a lower end and an upper end, an intake hopper 110 can be positioned at the lower end. An inlet rotary feeder 112 can be positioned between an intake hopper 110 and a drying bed conveyor 108. Increasing the size of an inlet rotary feeder 112 can eliminate plugging issues and provide better sealing and permit the passage of large pieces of material to be dried.

A drying bed 108 can further comprise a rotary screw conveyor 114. Dryer bed screw conveyors 114 can have full/smooth fighting with no cuts or folds nor any other known and/or convenient configuration.

An unloading screw 116 can be positioned at an upper end of a drying bed 108 and connected to a first airlock 118.

As shown in FIGS. 1a and 1b, an air-to-heat exchanger 120 can be positioned below a dryer bed conveyor 108 and above a lower plenum 104. In some embodiments an air-to-heat exchanger 120 can be a series of tubes inside a housing, but in other embodiments can be any other known and/or convenient device. Hot exhaust air from turbines can be blown through the tubes, warming them. As ambient air flows through an air-to-heat exchanger 120 it heats up and moves into a lower plenum 104 of the dryer.

A dryer intake fan 122 can intake ambient air to flow across a heat exchanger 120. As shown in FIG. 1a, a dryer housing 102 can further comprise at least one heating unit 124. In some embodiments, a dryer housing 102 can further comprise at least one louver panel 126 for ventilation. In some embodiments, a dryer housing 102 can further comprise an electrical control system 128 to regulate & monitor temperature, fan speeds, conveyor speeds, moisture content of material and overall system parameters.

In some embodiments, a dryer intake fan 122 can blow air through a heating unit 124 and heat exchanger 120 so the heated air can pass through an aeration screen 130 below a dryer bed conveyor 108. In some embodiments, an aeration screen 130 can be approximately 51% open and can have approximately 3/16″ holes on approximately ¾″ centers and can be comprised of 16 gage 304 Stainless Steel or any other known and/or convenient material. However, alternate geometries, percentages, sizes and spacing are contemplated. In some embodiments, the hole size can be selected as the particles to be dried were specified to be in a range of ¾″ to 2″ in size with very little fine material mixed in with the material to be dried. In some embodiments, changing an aeration screen 130 to use smaller holes in a more controlled pattern can better control air flow into product material. Aeration screens 130 can be installed in a triangular configuration on the sides of each of the dryer bed screw conveyors. However, alternate configurations are contemplated. In operation, as material is slowly conveyed along a dryer bed conveyor 108 it can be exposed to this heated air passing through the screens.

In some embodiments, a lower plenum 104 can be made from mild steel and, in addition to serving to convey/direct air to a dryer bed conveyor 108 can also support a dryer bed conveyor 108 and an upper plenum 106. In some embodiments, a lower plenum 104 can be insulated to help keep the desired temperature in place during the operation of the dryer. In some embodiments, there can be service doors in the side of a lower plenum 104 and an upper plenum 106 that can permit maintenance and inspection of a dryer bed conveyor 108. In some embodiments, there can also be louvers 126 in a lower plenum, depending on the fan settings. In some embodiments, louvers 126 can be automated. In operation, louvers 126 can exhaust or intake air in order to heat up or cool down the dryer temperature. Louvers 126 can be controlled using the temperature control system 130.

A dryer bed conveyor 108 can have a proximal end and a distal end and comprise at least one screw conveyor 114, which can be approximately 14″ diameter or any other known and/or convenient shapes, dimensions and/or geometries. In some embodiments screw conveyors 114 can be mounted within a rectangular trough 132, but in other embodiments can be any other known and/or convenient quantity. Each screw conveyor 114 can be powered via a 1-horsepower motor coupled to a 427:1 Gear Reducer and/or any other known, convenient and/or desired power source and gearing mechanism. Each screw conveyor assembly 114 can be approximately 39′-10″ long and/or have any other known, convenient and/or desired geometry. In some embodiments, screw conveyors 114 and a trough 132 can be made from 304 Stainless Steel or any other known and/or convenient material.

The length of this assembly can be determined, at least in part, by maximizing the space available on a dryer trailer; longer can be better given that retention time of material within the dryer can be critical. In some use cases, the biomass material was to be exposed to 100-degree Fahrenheit air for about 40 minutes in order to reduce the moisture content from approximately 80% to approximately 10%, if environmental conditions were ideal for dryer operation. Thus, in such use cases the material can move at a speed of approximately 1 foot/minute. However, alternate use cases are contemplated. The first half of the screw assembly can have the flights (screw-shaped metal) spaced at approximately 7″ on center, this is called half pitch flighting. The second half of the screw assembly can have the flights spaced at approximately 14″ on center, this is called full pitch fighting. However, alternate spacings are contemplated for each assembly. The half pitch flighting can advance material forward at approximately 7″ per revolution of the screw. The full pitch fighting can advance material forward at approximately 14″ per revolution of the screw. Thus, in some embodiments, when the wet material is first introduced to a dryer it is stirred and flipped twice as frequently than in the second half of screw conveyor before exiting the dryer bed. In some embodiments, the flighting can be comprised of approximately ¼″ 304 Stainless Steel and can be mounted on an approximately 5″ Schedule 40 304 Stainless Steel Pipe. The speed that the material can move through the dryer can be adjusted using a control system 128. If the material to be dried is very wet and it is a cool day, the screws can be run at a very low RPM to allow the material to be retained in the dryer longer than approximately 40 minutes. If the material is not very wet and it is a warm day, the screws can be run at a higher RPM to dry the material in less than 40 minutes.

An upper plenum 106 can completely cover a dryer bed conveyor 108. It can be comprised of mild steel or any other known and/or convenient material and can be insulated to help the dryer retain heat. The warm, moist airstream, which includes some fine material, can be pulled out of an upper plenum 106 with a plurality of with round duct openings spaced across the top of an upper plenum 106. In some embodiments, there can be 6 openings, each having a diameter of approximately 15″, but in other embodiments can have any other known and/or convenient geometry or configuration. An upper plenum 106 can comprise a service door to allow for maintenance and inspection of a dryer bed conveyor 108. The air space in a plenum 106 can be larger at inlet (wet) end of the dryer and smaller at the discharge (dry) end of the dryer. In such embodiments, this can permit the smaller particles to stay in the dryer longer and not get pulled into the fines collection system prematurely when they may still be too moist. If smaller particles are collected in the fines system, they should get pulled into the ducts nearer the dry portion of the dryer.

An upper plenum 106 can also house at least one optical moisture sensor 134, which can be located at the mid-point of a dryer bed 108; the other can be located near the discharge (distal) end of the dryer. However, in alternate embodiments, one or more sensors 134 can be positioned in any known, convenient and/or desired location. The sensors can permit the dryer to adjust the dryer bed conveyor 108 speed, air velocity and heat settings to ensure the material is being dried as desired. The moisture sensors can output a signal to the control system that is visible on the screen of a control system; on a screen it can show up as a moisture percentage of the material at each location.

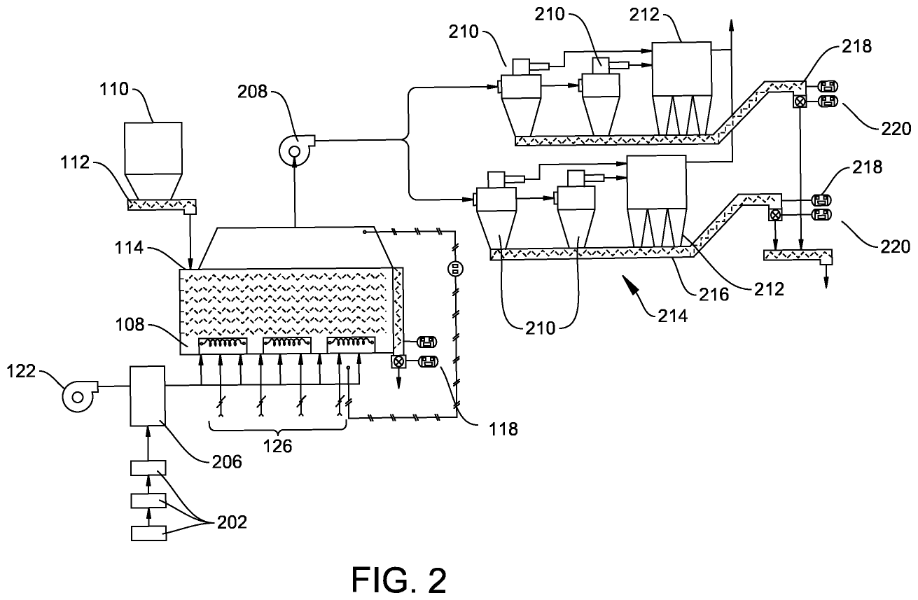

FIG. 2 depicts a schematic overview of an embodiment of the present system. In some embodiments, at least one microturbine 202 can be used to provide power to the necessary motors and heating unit s, as well as heat to help heat the ambient air. Turbines 202 can also further comprise a fuel conditioning system comprising a pump, vaporizer and regulators, and be fueled with liquid propane. Microturbines 202 can have a power rating of approximately 65 Kilowatts or any other known and/or convenient value. In some embodiments, the present system can employ three (3) turbines, but in other embodiments can comprise any other known and/or convenient quantity.

In some embodiments an intake fan 204 can intake ambient air and direct it to a mixing chamber 206 to mix with the heated exhaust of microturbines 202 or into a heat exchanger 120. Heated air can then rise through a drying bed conveyor 108. In some embodiments, a drying bed conveyor 108 can further comprise at least one rotary screw 114 to move biomasses along a drying bed 108. A discharge screw 116 can remove biomasses from a dryer bed conveyor 108 and direct them to a discharge airlock 118.

An inlet hopper 110 can be located at the proximal end of a dryer bed conveyor 108 and direct material into a rotary feeder 112. A hopper 110 can be comprised of 304 Stainless Steel and can have two sloped sides and two vertical sides, or any other known and/or convenient geometry, or any other known and/or convenient material. In some embodiments, a hopper 110 can be filled using an external belt conveyor with a variable speed drive, but in other embodiments can use any other known and/or convenient device. A hopper 110 can be sized to be as large as possible for where it is located in the system, the vertical sides are nearly the full width of the trailer, the sloped sides are angled to reduce the likelihood of bridging and to help material flow into a rotary feeder 112.

A rotary feeder 112 can meter the wet material into dryer bed screw conveyors 114. A rotary feeder 112 can comprise pockets into which material from a hopper 110 falls, as a rotary feeder turns, the material drops into the dryer bed screw conveyors 114. The rotor pockets can be lined with ultra-high-molecular-weight (UHMW) polyethylene to promote material flow and prevent wear on a rotary feeder 112. Using a rotary feeder 112 in this location can aid the heated air in the dryer, as the pockets can help block the heated air from flowing out into a hopper 110, this helps the dryer maintain the desired temperature. A rotary feeder 112 can be powered with a 2 Horsepower motor and/or any other know, convenient and/or desired power source. The speed can be adjusted via an electronic control system 128.

As the dry material moves to the distal end of a dryer bed conveyor 108 it can drop into the product discharge conveyor 116, and be conveyed into the dry product rotary airlock 118. The dry product discharge conveyor 116 can be an approximately 9″ diameter screw conveyor 114 (any other any other known, convenient and/or desired conveyor apparatus or system) that is powered by a 1 horsepower motor and/or any other known, convenient and/or desired power source. In some embodiments, one or both of the screw conveyor 114 and a trough 132 can be made from 304 Stainless Steel or any other known and/or convenient material

A dry product rotary airlock 118 can be located at the end of a product discharge conveyor 116. In some embodiments, a dry product rotary airlock 118 can be a Koger 8″ Square Model, powered by a 2-horsepower motor. However alternate components are contemplated. The blades of an airlock 118 can have rubber paddles attached to them to allow irregularly shaped material to flow out of an airlock 118. An airlock 118 can also block heated air from coming out the dryer, aiding the dryer in maintain a desired temperature. Once the material comes out of a dry product rotary airlock 118, it can be conveyed to an end user's preferred method of transportation or storage.

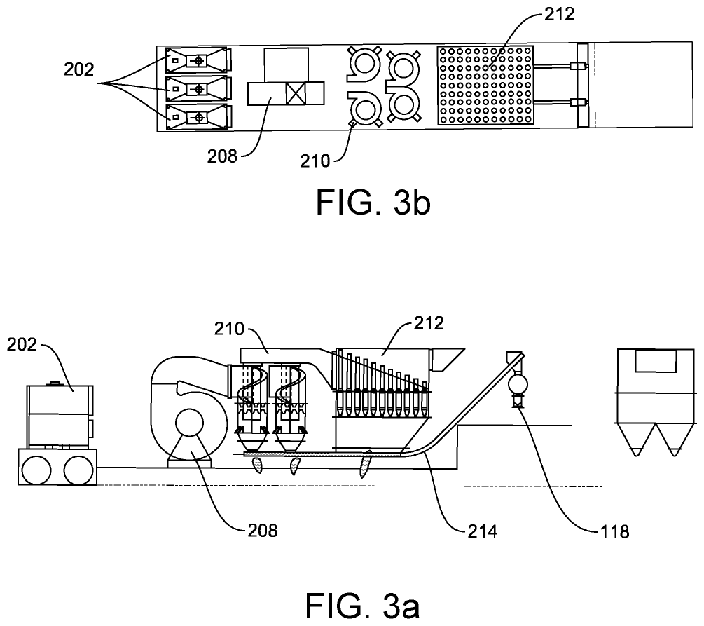

FIGS. 3a and 3b depict a detail view of a particle collection system. In some embodiments, heated air blows through a perforated drying bed conveyor 108, aerating the material and exposing it to heated air. As screw conveyors 114 rotate and move material forward, the material is flipped & stirred to further expose it to the warm air. Heated air that has passed through a drying bed conveyor 108 can continue to rise and be ducted to a collection fan 208, which can blow the rising air and particles (“fine product”) to at least one primary cyclone separator 210. From there the air goes to at least one multi-cyclone separator 212. Fine product can fall through a primary cyclone separator 210 and secondary multi-cyclone separator 212 to a duct 214 that can have a rotary conveyor screw 216 to direct fine product to an unloading screw 218 and into an airlock 220. A particle collection system can pull the warm, moist air from an upper plenum 106 of a dryer bed conveyor 108 and separate the dried fine product from the moist air stream and convey it to a storage vessel.

In some embodiments, a collection fan 208 can be approximately 28,000 CFM and cam be powered by an approximately 75-Horsepower motor. In alternate embodiments, alternate components and capacities are contemplated. A collection fan 208 can pull warm, moist air from an upper plenum 106 of the dryer and blow it into a primary cyclone 210 and secondary multi-cyclone particle separators. This air stream can contain particles in the range of approximately ¾″ to 2, along with particles down to approximately less than or equal to 5 microns. A collection fan 208 can be sized so that when the dryer is running at the desired temperature and can be held there, the upper plenum 106 can become a negative pressure area. This can aid in pulling heat through the material as it is being conveyed along a dryer bed conveyor 108. A collection fan 208 can aid in keeping an upper plenum's 106 relative humidity at a manageable/desirable level, as it is can constantly pull the heated dry air through an aeration screen 130 and use that air to replace the moisture-laden air it is pulling out of an upper plenum 106. In some embodiments, a collection fan 208 can change the air in an upper plenum 106 approximately 29 times per minute when the dryer is operating at peak capacity and/or at any known, convenient and/or desired rate. A collection fan 208 can be controlled using a control system 128 and can be adjusted as needed for environmental conditions.

Some embodiments can have four primary cyclone separators 210 that can be 34″-diameter high-efficiency cyclones joined with a common duct system. However, other embodiments can have any other known and/or convenient quantity. Primary cyclone separators 210 can be made from mild steel but coated on the interior and exterior with epoxy paint to protect them from moisture. They can remove most of the moisture from the air stream and also remove particles greater than or equal to approximately 25 microns from the air stream. These particles can fall into flexible screw dust collection conveyors 216. Primary cyclone separators 210 can be selected and/or adapted and configured to separate particulate matter because they are very good at handling irregularly shaped particles of varying sizes with minimal plugging issues; they are also easy to maintain as they have no moving parts.

After the air stream passes through the primary cyclone separators 210 it can travel into at least one secondary multi-cyclone separator 212. In some embodiments, at least one secondary multi-cyclone separator 212 can comprise approximately 99 6″ high-efficiency cyclone assemblies. The housing can be made from mild steel that can be coated on the interior and exterior with epoxy. A secondary multi-cyclone separator 212 can be made from corrosion resistant galvanized steel. A secondary multi-clone separator 212 can remove particles from the airstream greater than or equal to approximately 5-8 microns and/or any known, convenient and/or desired size. These small particles can be collected in the hopper of the secondary multi-clone separator 212 and conveyed into a collection system using the same flexible screw dust collection conveyors 216 that are coupled with the primary cyclones. Once the air stream has been through the secondary multi-clone separator it can be exhausted to atmosphere.

Flexible screw conveyors 216 can be attached to discharge points of both a primary separator 210 and a secondary separator 212. In some embodiments they can be approximately 3″ diameter screws and powered with 1-horsepower motors, but in other embodiments can have any other known and/or convenient configuration. Flexible screw conveyors 216 can discharge into the particle collection airlocks 220, which can be 8″ Square Koger Airlocks, powered with 2-horsepower motors, or any other known and/or convenient device. However, alternate structures and configurations are contemplated. Rotary airlocks 220 can discharge into a fine product discharge conveyor 218, which, in some embodiments can be a approximately 9″ diameter screw conveyor housed in a U-shaped trough and powered with a 1-horsepower motor. However, alternate structures and construction are contemplated. The fine product discharge conveyor 218 can be designed to empty into supersacks/totes for storage/transportation.

In some embodiments, the fine product being collected can be very valuable to the end-user, as it contains the isolate particles which are refined into a very pure grade product. The fine product collection system can capture approximately 97% of these particles greater than or equal to 5-8 micron, allowing the end user to efficiently process product with very little waste. However, in alternate embodiments, different and/or different capacity components may be utilized, additional components can be present and/or some components can be absent.

The heat to operate the dryer can be supplied by the exhaust gas from at least one propane fueled C65 Turbine 202 and a heating unit 124. In some embodiments, when three turbines are running near peak energy output, 1.5 million BTU/Hour can be produced, and the exhaust gas temperature can run as high as 588 degrees Fahrenheit. Initial research revealed that 2.2 to 2.5 million BTU/Hour would be desirable to dry selected biomasses, such as, but not limited to hemp, at a temperature of 90 to 130 degrees Fahrenheit. However, alternate heat profiles can be utilized. The figures accompanying this disclosure are based on the initial moisture content being 80% and the dry moisture content being 10%. However, alternate profiles are contemplated. If the ambient temperature is less than about 75 degrees Fahrenheit, additional heat may be required. Given that there would be times during drying when the turbines would not be running near peak energy output, an additional 5.4 million BTU Heat Source can be added such that when environmental conditions lead to downturns in the turbine output, the dryer can function.

In some embodiments, heat can be supplied from turbines 202 to the dryer by ducting the exhaust gasses into an approximately 14″ duct that can be connected to the inlet of a heat exchanger 120. A heat exchanger 120 can have a lower plenum 104 that the exhaust gasses go through first; once through the lower plenum they can be blown into an upper plenum and then can be expelled to atmosphere. In some embodiments, a single pass heat exchanger 120 can be employed however, in alternate embodiments, a double-pass (or multi-pass) (upper/lower section) heat exchanger 120 can be utilized. In some embodiments, the present system can keep the exhaust gasses in a heat exchanger 120 longer and help to keep the dryer air warmer for more efficient drying. In some embodiments, there can be approximately 186 sets of 2.25″ round steel tubes in a heat exchanger 120. However, in alternate embodiments any known, convenient and/or desire count can be utilized.

Some embodiments can employ a 5.4 million BTU Heating unit 124, which was not available initially but can be installed between a heat exchanger 120 and a dryer intake fan 122. A heating unit 124 can run on liquid propane, the same fuel source as the turbines, and can raise the ambient temperature up to approximately 180 degrees Fahrenheit when running at peak output; however, alternate fuels sources are contemplated. It can be controlled with a programmable, modulating fuel intake valve which can be coupled with the electronic temperature control system 130. This heating unit 124 can be used at start-up of the dryer to raise the internal dryer temperature quickly and/or when the ambient temp is below a prescribed temperature, such as, in some exemplary embodiments, approximately 70 degrees Fahrenheit.

The heat generated from turbines 202, heat exchanger 120 and/or an additional heating unit 124 can be blown through the dryer with a dryer intake 122. A dryer intake fan 122 fan can be approximately 23,500 CFM (and or any other any other known, convenient and/or desired operational capacity) and can be powered with a 40-horsepower motor and/or any other known, convenient and/or desired power source. A dryer intake fan 122 can intake ambient air and blow it through a heating unit 124 and a heat exchanger 120 into a lower plenum 104 of a dryer bed conveyor 108. In some embodiments, as a lower plenum 104 fills with heated air, the heated air can pass though aeration holes in a dryer bed conveyor 108. The flow rate can create a velocity of approximately 200-250 feet per minute and/or any other known, convenient and/or desired flow velocity; this is the air that blows through and into the material being dried. This air can heat the material and can aid in expelling moisture in the material into the exhaust air stream of the dryer. A dryer intake fan 122 speed/flow rate can be controlled by a control system 130.

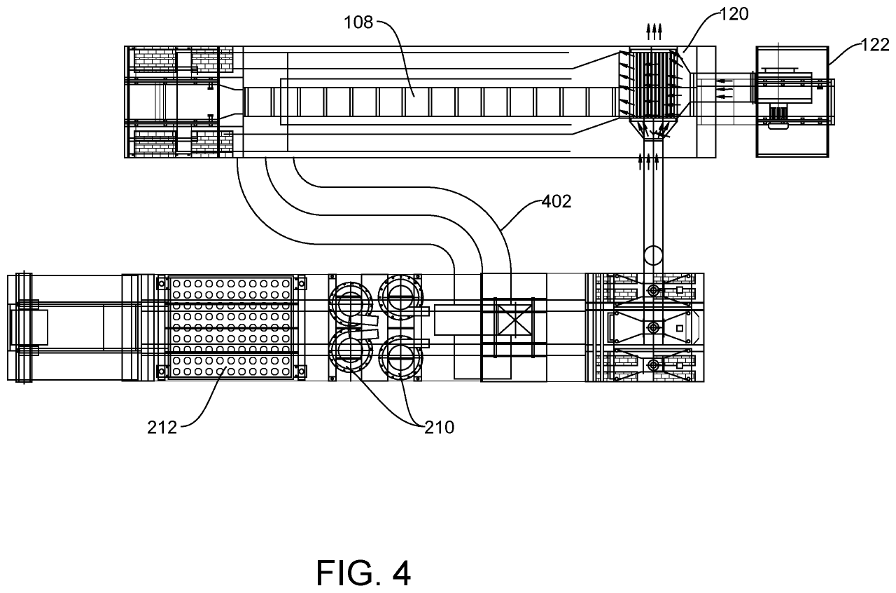

FIG. 4 depicts an embodiment of the present system in which the product drying and fine product collection systems can operate side-by-side. In some embodiments, the dryer can be adjusted via the a screen monitor that can shows at least some of the electrical devices. Both the fan 122 208 motors, the dryer bed screw 114 motors, and the intake rotary feeder 112 motor can be run via Variable Frequency Drives. This permits the motors to be run at speeds from approximately 20% to 100% of their full capacity, these motors can be adjusted in 1% increments, as desired. This amount of adjustment is useful so that the dryer can be tuned to meet the demands of the material to be dried.

In some embodiments, electrical power can be supplied to the dryer with (3) 65 Kilowatt Microturbines, turbine 202 are fueled with liquid propane. Turbines 202 can run on propane vapor, the liquid propane is first supplied to a vaporizer to create the propane vapor, it is then plumbed to a fuel regulation system to be distributed to the (3) turbines 202. All the fuel supply pipes can be insulated and wrapped with heat tracing cable. However, alternate power sources are contemplated. The heat tracing cable can maintain the fuel temperature so that the propane vapor does not cool to the point of saturation and return to its liquid state. To condition the fuel, the vaporizer can run, so an auxiliary generator can be used to power the vaporizer and fuel pipe heat trace system until the turbines are started and can export power. The fuel system can be designed so that it can keep the generators running at temperatures from 20 degrees Fahrenheit up to (and over) 100 degrees Fahrenheit. In some embodiments, the system can run at sea level and can be designed to also run at altitudes up to 5000 feet above sea level.

In some embodiments, the (3) turbines 202 can be mounted side by side at the rear of the power trailer as shown in FIG. 4, although alternate configurations are contemplated. Periodic maintenance & inspection can be done on the internal parts of the turbines, outer (2) turbines 202 can be mounted permanently to the rear trailer deck. In some embodiments, the middle turbine is mounted on a track that allows it be rolled off the rear deck onto support legs so that the side covers of the turbine can be accessed & removed for inspection/maintenance purposes. In the transport position this track can be pinned in place and the support legs are stowed for transportation.

Once turbines 202 are started and exporting electrical power, the power can be run into a distribution panel that splits the power as needed between the (2) trailers, as shown in FIG. 4. The fine product collection system can be on the same trailer as the turbines in some embodiments. The balance of the equipment can on the other trailer with a dryer bed conveyor 108. In some embodiments, there can be a power cord that runs between the trailers as well as a network cable. However, alternate configurations are contemplated. The variable frequency drive and circuit breakers for the fine product collection system can all be housed on the power trailer and they are controlled via the monitor/panel on the dryer trailer. The voltages for all the large motors can be 460 Volt (3-Phase), but there are also 110 Volt circuitries along with 24 Volt control wiring in the system. Moreover, alternate voltages and frequencies are contemplated. Some or all of the electrical controls can be housed in weather-tight enclosures. The electrical panels inside the enclosures can be customized.

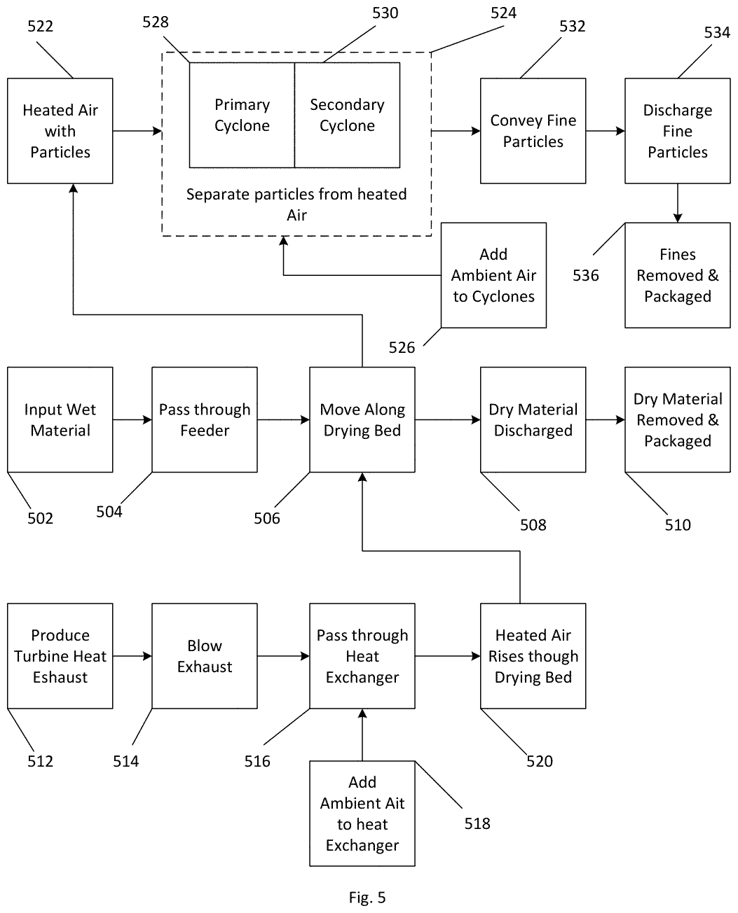

FIG. 5 depicts a flow chart of a method using the present system . . . . In some embodiments, a method can comprise the following steps: Wet biomass material can be placed in an inlet hopper 110 502 and pass through an inlet feeder 112 504. Wet material can move along a drying bed conveyor 108 506. At the distal end of a drying bed conveyor 108, dry product material can be discharged 508 and removed and packaged 510. Turbines 202 can produce heated exhaust 512. Fan 208 can blow this exhaust 514 into a heat exchanger 120. Ambient air can be added to a heat exchanger 120 518. Heated exhaust can pass through a heat exchanger 120 516. Heated air can pass through a drying bed conveyor 108 510. Heated air that has passed through a drying bed conveyor 108 can contain fine product particles 522, which can be separated from this heated air 524. Ambient air can be added to cyclonic particle separators 210 212 526. Heated air can pass through at least one primary cyclone particle separator 210 528. Heated air can pass through at least one secondary multi-cyclone particle separator 212 530. Fine product particles can be conveyed away from particle separators 210 212 532. Fine product particles can be discharged 534, Fine product particles can be removed and packaged 536.

The dryer can be a controlled programmable system built to gather data and allow necessary adjustments to account for varying environmental and material conditions. In some embodiments, the computer can be an Allen Bradley unit with multiple input cards, it can also have network capabilities, such that once the system is powered up, it can be logged into from anywhere with an internet connection. This gives the operator additional support if an issue arises to monitor the (3) turbines that supply power as well. In some embodiments the turbines can be initially started via the control system to initialize the turbine start up and see that process through to the point where the turbines are exporting power to the system. If there are any malfunctions with the turbines, the network capability can be used to log into the individual control system for each turbine.

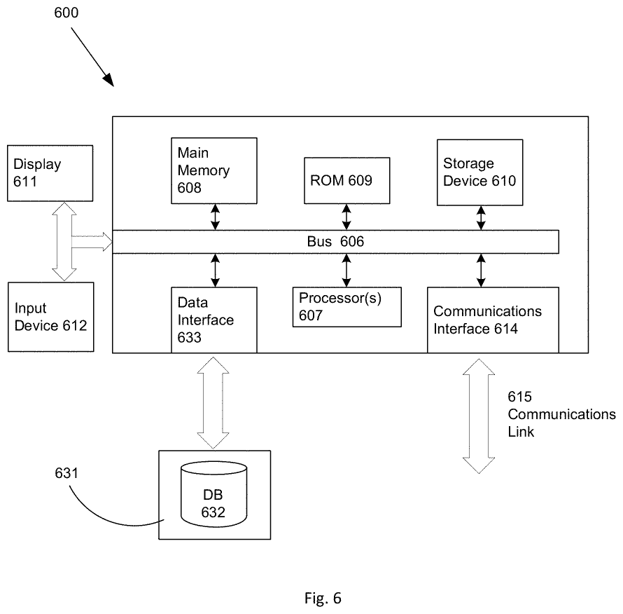

The execution of the sequences of instructions required to practice the embodiments can be performed by a computer system 600 as shown in FIG. 6. In an embodiment, execution of the sequences of instructions is performed by a single computer system 600. According to other embodiments, two or more computer systems 600 coupled by a communication link 615 can perform the sequence of instructions in coordination with one another. Although a description of only one computer system 600 will be presented below, however, it should be understood that any number of computer systems 600 can be employed to practice the embodiments.

A computer system 600 according to an embodiment will now be described with reference to FIG. 6, which is a block diagram of the functional components of a computer system 600. As used herein, the term computer system 600 is broadly used to describe any computing device that can store and independently run one or more programs.

Each computer system 600 can include a communication interface 614 coupled to the bus 606. The communication interface 614 provides two-way communication between computer systems 600. The communication interface 614 of a respective computer system 600 transmits and receives electrical, electromagnetic or optical signals, that include data streams representing various types of signal information, e.g., instructions, messages and data. A communication link 615 links one computer system 600 with another computer system 600. For example, the communication link 615 can be a LAN, in which case the communication interface 614 can be a LAN card, or the communication link 615 can be a PSTN, in which case the communication interface 614 can be an integrated services digital network (ISDN) card or a modem, or the communication link 615 can be the Internet, in which case the communication interface 614 can be a dial-up, cable or wireless modem.

A computer system 600 can transmit and receive messages, data, and instructions, including program, i.e., application, code, through its respective communication link 615 and communication interface 614. Received program code can be executed by the respective processor(s) 607 as it is received, and/or stored in the storage device 610, or other associated non-volatile media, for later execution.

In an embodiment, the computer system 600 operates in conjunction with a data storage system 631, e.g., a data storage system 631 that contains a database 632 that is readily accessible by the computer system 600. The computer system 600 communicates with the data storage system 631 through a data interface 633. A data interface 633, which is coupled to the bus 606, transmits and receives electrical, electromagnetic, or optical signals, that include data streams representing various types of signal information, e.g., instructions, messages and data. In embodiments, the functions of the data interface 633 can be performed by the communication interface 614.

Computer system 600 includes a bus 606 or other communication mechanism for communicating instructions, messages and data, collectively, information, and one or more processors 607 coupled with the bus 606 for processing information. Computer system 600 also includes a main memory 608, such as a random-access memory (RAM) or other dynamic storage device, coupled to the bus 606 for storing dynamic data and instructions to be executed by the processor(s) 607. The main memory 608 also can be used for storing temporary data, i.e., variables, or other intermediate information during execution of instructions by the processor(s) 607.

The computer system 600 can further include a read only memory (ROM) 609 or other static storage device coupled to the bus 606 for storing static data and instructions for the processor(s) 607. A storage device 610, such as a magnetic disk or optical disk, can also be provided and coupled to the bus 606 for storing data and instructions for the processor(s) 607.

A computer system 600 can be coupled via the bus 606 to a display device 611, such as, but not limited to, a cathode ray tube (CRT) or a liquid-crystal display (LCD) monitor, for displaying information to a user. An input device 612, e.g., alphanumeric, and other keys, is coupled to the bus 606 for communicating information and command selections to the processor(s) 607.

According to one embodiment, an individual computer system 600 performs specific operations by their respective processor(s) 607 executing one or more sequences of one or more instructions contained in the main memory 608. Such instructions can be read into the main memory 608 from another computer-usable medium, such as the ROM 609 or the storage device 610. Execution of the sequences of instructions contained in the main memory 608 causes the processor(s) 607 to perform the processes described herein. In alternative embodiments, hard-wired circuitry can be used in place of or in combination with software instructions. Thus, embodiments are not limited to any specific combination of hardware circuitry and/or software.

The term “computer-usable medium,” as used herein, refers to any medium that provides information or is usable by the processor(s) 607. Such a medium can take many forms, including, but not limited to, non-volatile, volatile and transmission media. Non-volatile media, i.e., media that can retain information in the absence of power, includes the ROM 609, CD ROM, magnetic tape, and magnetic discs. Volatile media, i.e., media that cannot retain information in the absence of power, includes the main memory 608. Transmission media includes coaxial cables, copper wire and fiber optics, including the wires that comprise the bus 606. Transmission media can also take the form of carrier waves; i.e., electromagnetic waves that can be modulated, as in frequency, amplitude or phase, to transmit information signals. Additionally, transmission media can take the form of acoustic or light waves, such as those generated during radio wave and infrared data communications.

In the foregoing specification, the embodiments have been described with reference to specific elements thereof. It will, however, be evident that various modifications and changes can be made thereto without departing from the broader spirit and scope of the embodiments. For example, the reader is to understand that the specific ordering and combination of process actions shown in the process flow diagrams described herein is merely illustrative, and that using different or additional process actions, or a different combination or ordering of process actions can be used to enact the embodiments. The specification and drawings are, accordingly, to be regarded in an illustrative rather than restrictive sense.

It should also be noted that the present invention can be implemented in a variety of computer systems. The various techniques described herein can be implemented in hardware or software, or a combination of both. Preferably, the techniques are implemented in computer programs executing on programmable computers that each include a processor, a storage medium readable by the processor (including volatile and non-volatile memory and/or storage elements), at least one input device, and at least one output device. Program code is applied to data entered using the input device to perform the functions described above and to generate output information. The output information is applied to one or more output devices. Each program is preferably implemented in a high-level procedural or object-oriented programming language to communicate with a computer system. However, the programs can be implemented in assembly or machine language, if desired. In any case, the language can be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The system can also be considered to be implemented as a computer-readable storage medium, configured with a computer program, where the storage medium so configured causes a computer to operate in a specific and predefined manner. Further, the storage elements of the exemplary computing applications can be relational or sequential (flat file) type computing databases that are capable of storing data in various combinations and configurations.

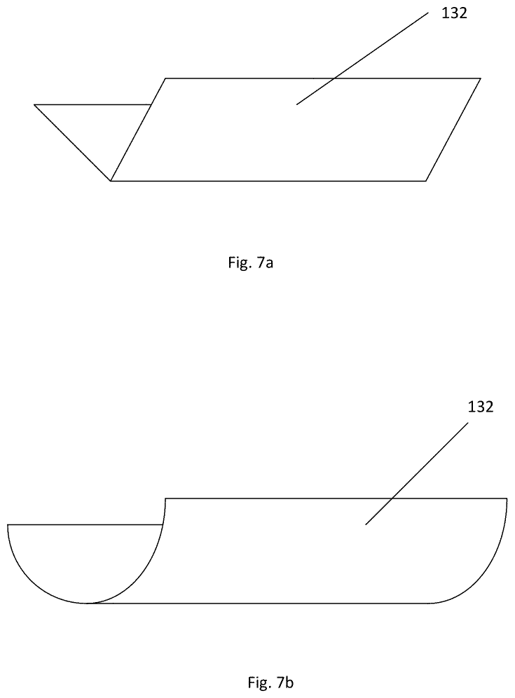

FIGS. 7a and 7b depict cross-sectional views of dryer bed conveyor troughs 132. In some embodiments, a dryer bed conveyor trough 132 can have an angled trough design, as shown in FIG. 7a. In other embodiments, a dryer bed conveyor trough 132 can have a radius cross section to better fit round screw conveyors 114. In still other embodiments, a dryer bed conveyor trough 132 can have any other known and/or convenient geometry.

It will be obvious to one of ordinary skill in the art that alternate construction and/or components can make the dryer more versatile and able to work with many different materials and in numerous different exterior conditions. The heating system can raise ambient temperature up to 200-degrees F. Given this level of heat the fans can be run at speeds tailored to match the ideal aeration velocity of the material. This can permit the material to flow efficiently through the dryer and be conveyed in a consistent manner. The heat, airflow and conveyance speeds can all be adjusted via the control system, thus material with a high moisture content can be conveyed slowly and dried using high heat and airflow settings or material with a lower moisture content can be conveyed faster using lower heat and airflow settings to get to the desired drying rate. The dryer can be used with these adjustable features to tailor the machine to match the ambient and material conditions to dry as efficiently in accordance with conditions.

Although exemplary embodiments of the invention have been described in detail and in language specific to structural features and/or methodological acts above, it is to be understood that those skilled in the art will readily appreciate that many additional modifications are possible in the exemplary embodiments without materially departing from the novel teachings and advantages of the invention. Moreover, it is to be understood that the subject matter defined in the appended claims is not necessarily limited to the specific features or acts described above. Accordingly, these and all such modifications are intended to be included within the scope of this invention construed in breadth and scope in accordance with the appended claims.

What is claimed:

1. A biomass drying system comprising:
a dryer housing further comprising an upper plenum and a lower plenum;
at least one microturbine connected to a first inlet fan, which is ducted to a heat exchanger housed in said lower plenum;
a second inlet fan connected to said heat exchanger;
a drying bed conveyor having a proximal end and a distal end;
an inlet hopper located at said proximal end of said drying bed conveyor;
a rotary feeder located below said inlet hopper and above said drying bed conveyor;
a discharge screw located at said distal end of said drying bed conveyor a first discharge airlock located below said discharge screw;
a third inlet fan located above said drying bed conveyor;
at least one primary cyclone separator;
at least one secondary cyclone separator;
a dust collection conveyor;
a second discharge airlock; and
an electrical control system.

2. The system of claim 1, further comprising a heating unit located in said lower plenum.

3. A biomass drying method comprising the steps of:
inputting wet biomass material via a hopper;
passing wet material through a rotary feeder;
moving material along a drying bed conveyor;
discharging dry material to an airlock; and
removing and packaging said dry material.

4. The method of claim 3, further comprising the steps of:
running at least one turbine to produce heated exhaust;
blowing and ducting said heated exhaust into a heat exchanger;
ducting heated air from said heat exchanger upward through a drying bed conveyor;
capturing and ducting heated air containing particles above said drying bed conveyor;
passing said heated air through at least one primary cyclone;
passing said heated air through at least one secondary cyclone;
collecting separated fine particles on a conveyor;
discharging fine particles into an airlock; and
removing and packaging said fine particles.
